(19) United States
(12) Patent Application Publication
(10) Pub. No.: US 2025/0315856 A1
(43) Pub. Date: Oct. 9, 2025

(54) GENERATIVE ARTIFICIAL INTELLIGENCE (AI) CONTENT STRATEGY

(71) Applicant: Adobe Inc., San Jose, CA (US)

(72) Inventors: Chang Xiao, Sunnyvale, CA (US); Zeus Courtois, Austin, TX (US); Sonali Surange, San Rafael, CA (US); Jacob Benjamin Hanson-Regalado, Benicia, CA (US); Eunyee Koh, San Jose, CA (US); Gavin Stuart Peter Miller, Los Altos, CA (US)

(73) Assignee: Adobe Inc., San Jose, CA (US)

(21) Appl. No.: 18/625,484

(22) Filed: Apr. 3, 2024

(51) Int. Cl. G06Q 30/0207; G06Q 30/0204; G06Q 30/0226

(52) U.S. Cl. CPC G06Q 30/0212; G06Q 30/0205; G06Q 30/0226

(57) ABSTRACT

Generative artificial intelligence (AI) content strategy techniques are described. In one or more examples, a content brief is received describing a goal to be achieved in controlling digital content output. Content brief data is extracted from the content brief and a content strategy is generated based on the content brief data using generative artificial intelligence implemented using one or more machine-learning models.

### BACKGROUND

Conventional techniques used to develop content strategies to control digital content output rely on specialized knowledge and skills typically developed over significant amounts of time. Further, even when this specialized knowledge is gained these techniques generally involve a “best guess” regarding wants and desires of an audience that is to receive the digital content, which may change over time. As a result, conventional techniques involve consumption of significant amounts of computational resources and support limited insight into performance of the strategies until completion.

### SUMMARY

Generative artificial intelligence (AI) content strategy techniques are described. In one or more examples, a content brief is received describing a goal to be achieved in controlling digital content output. Content brief data is extracted from the content brief and a content strategy is generated based on the content brief data using generative artificial intelligence implemented using one or more machine-learning models.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

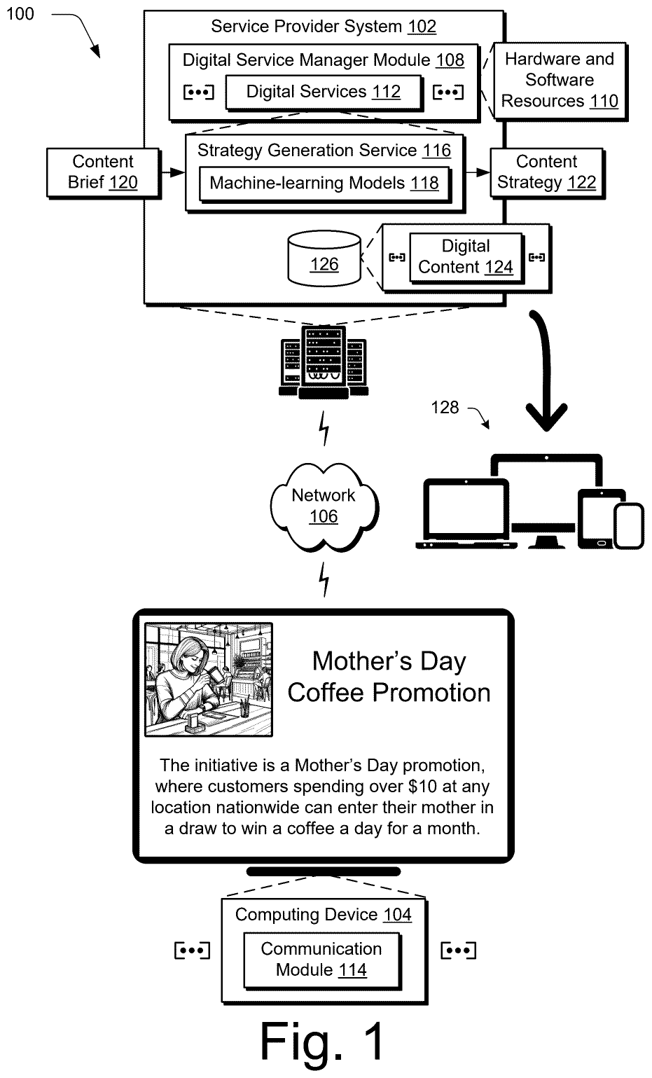

FIG. 1 is an illustration of an environment in an example implementation that is operable to employ generative artificial intelligence (AI) content strategy generation techniques described herein.

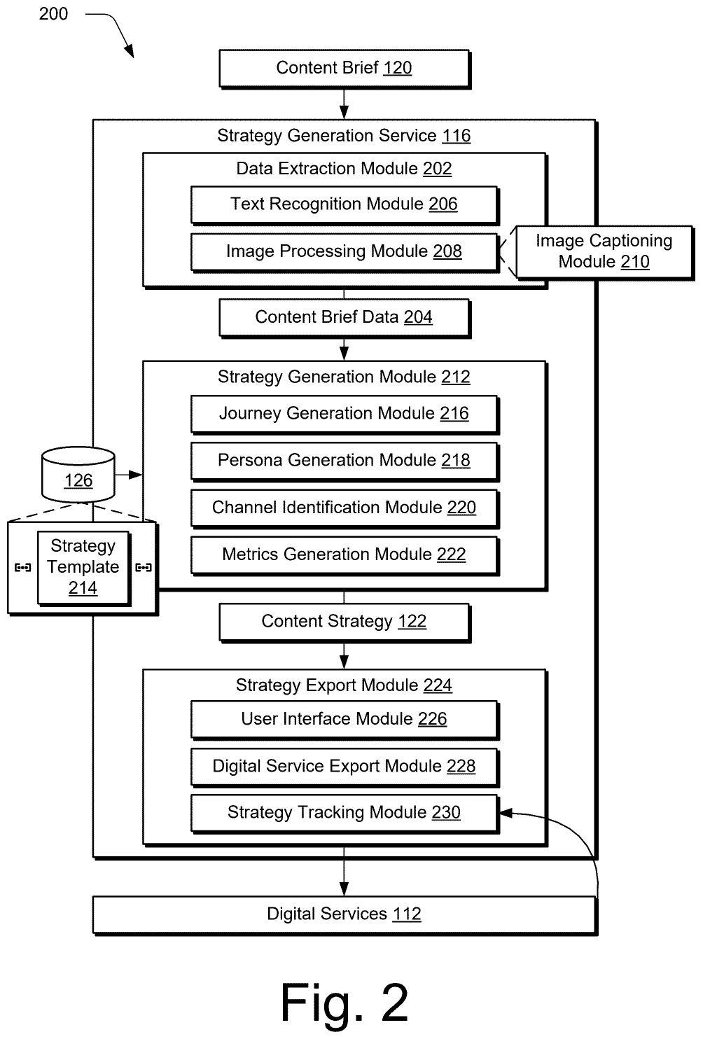

FIG. 2 depicts a system in an example implementation showing operation of a strategy generation service of FIG. 1 in greater detail and generating a content strategy from a content brief.

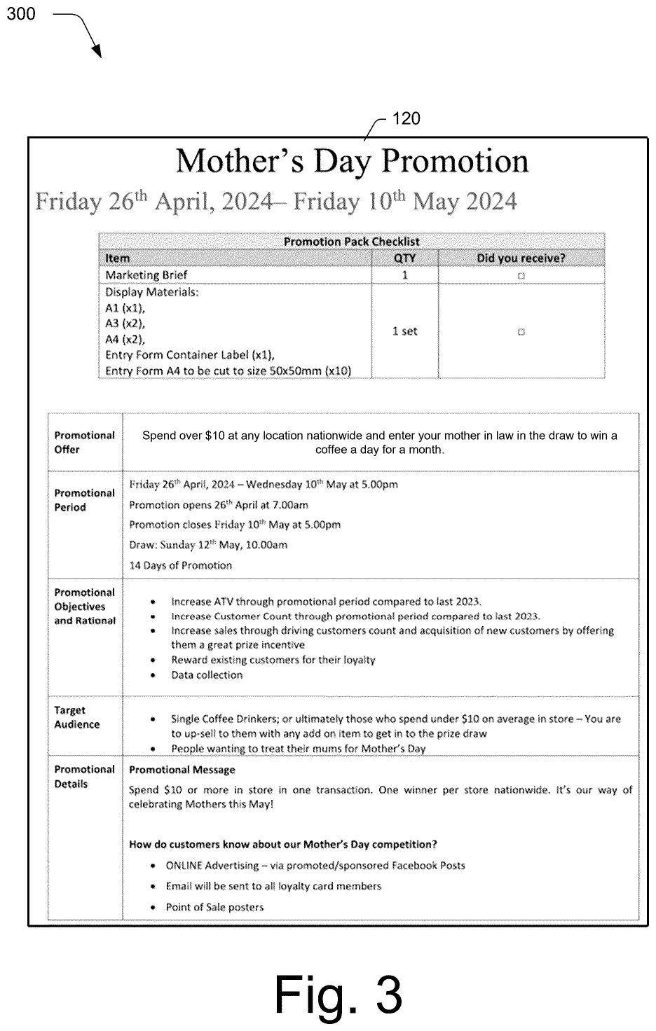

FIG. 3 depicts an example implementation of a content brief.

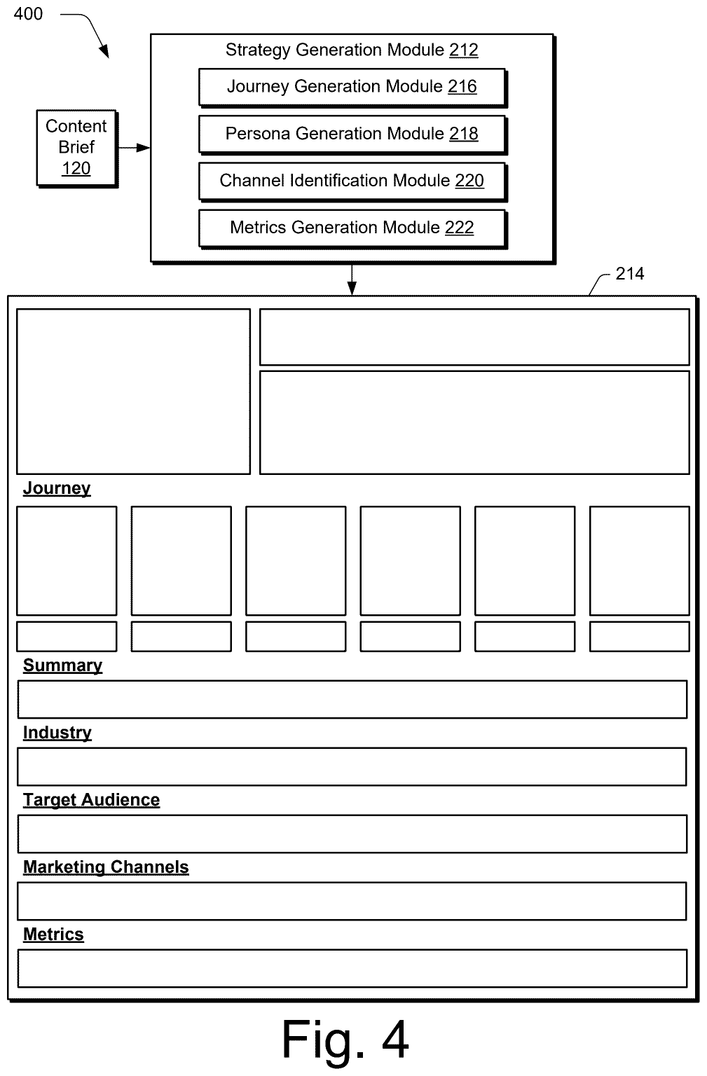

FIG. 4 depicts an example implementation in which a strategy generation module of FIG. 2 is employed to populate portions of a strategy template using respective modules to implement generative artificial intelligence to generate text and/or digital images based on the content brief.

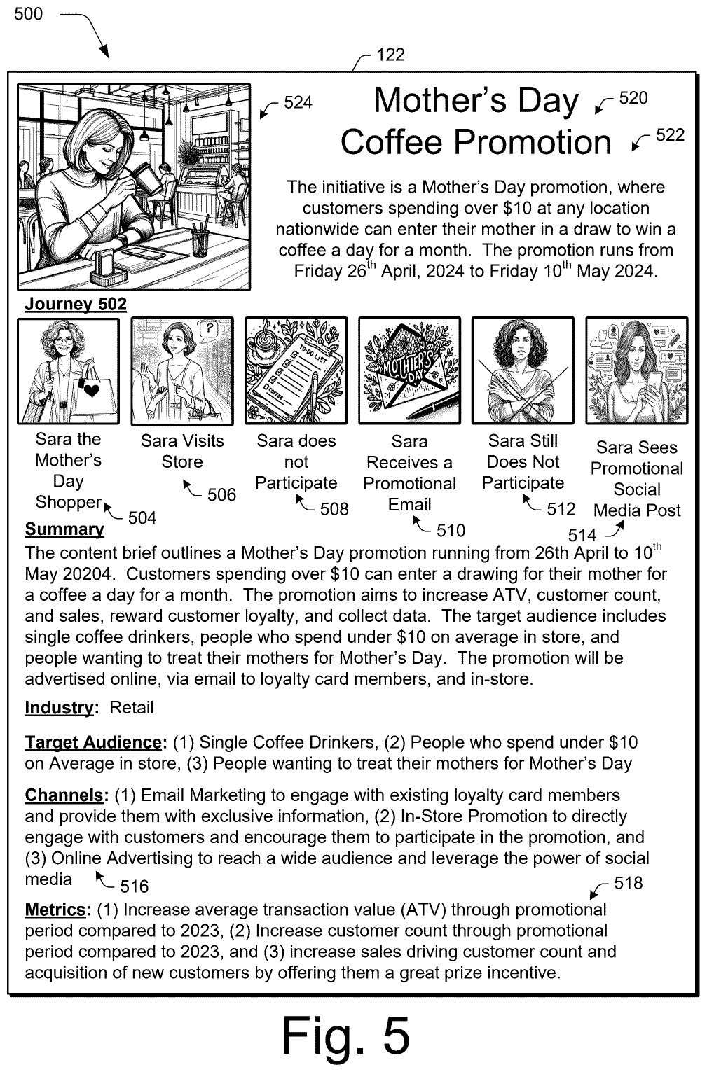

FIG. 5 depicts an example implementation showing a content strategy as having respective portions the strategy template populated using generative artificial intelligence as implemented using respective modules based on the content brief.

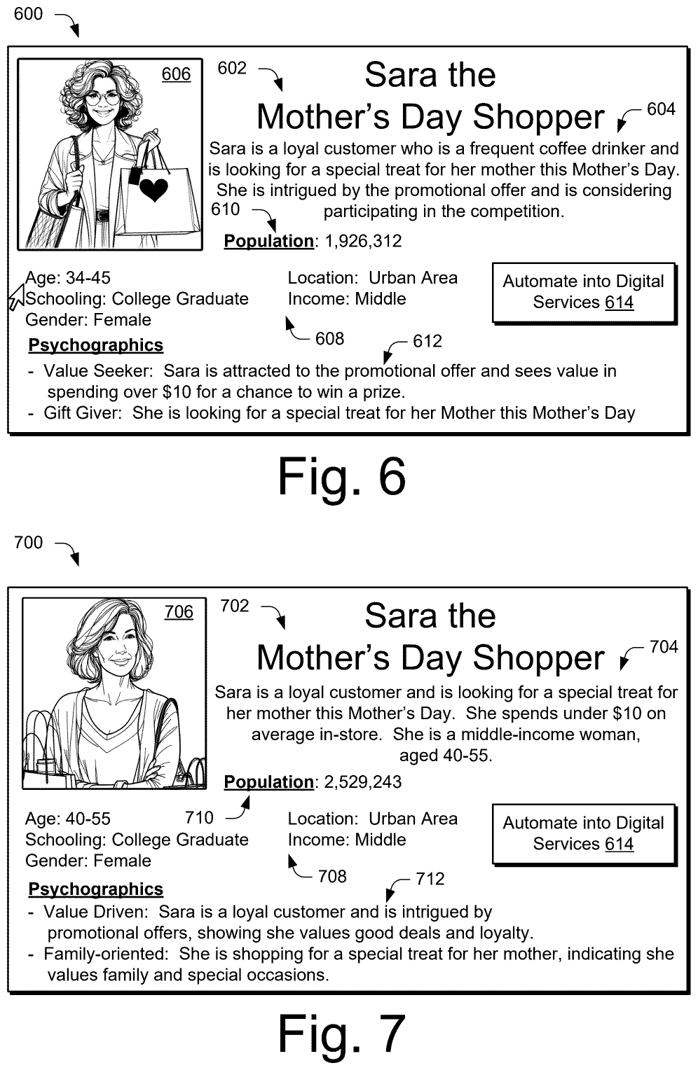

FIG. 6 depicts an example implementation of output of a persona in a user interface as generated by a persona generation module.

FIG. 7 depicts an example implementation of output of a persona in a user interface as generated by a persona generation module based on one or more edits to a persona of FIG. 6.

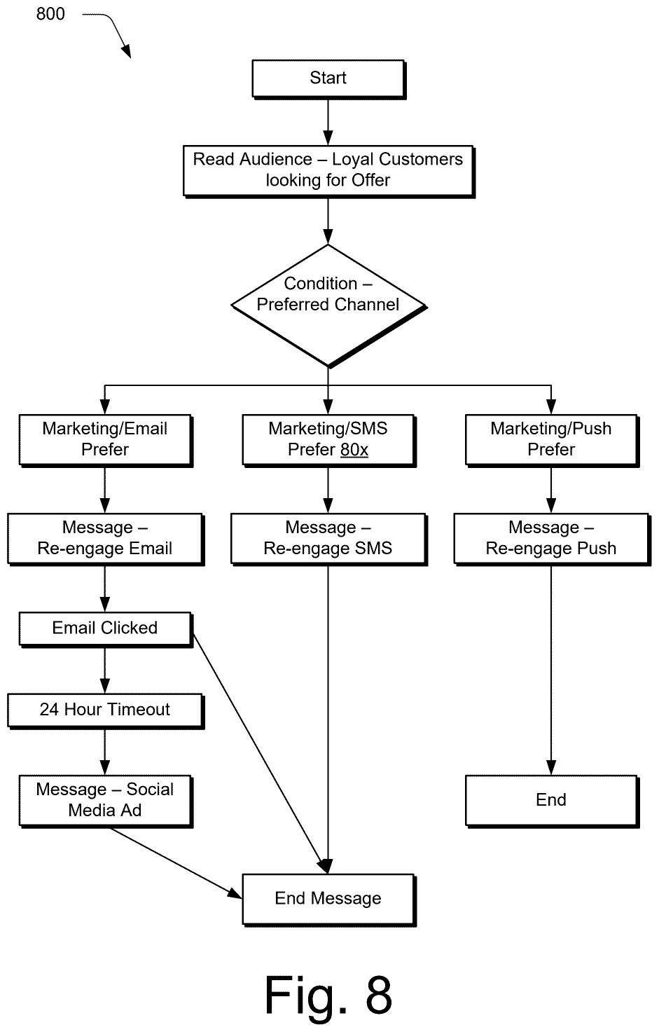

FIG. 8 depicts an example of a user interface depicting a journey and respective metrics usable to track performance of a content strategy generated using generative artificial intelligence.

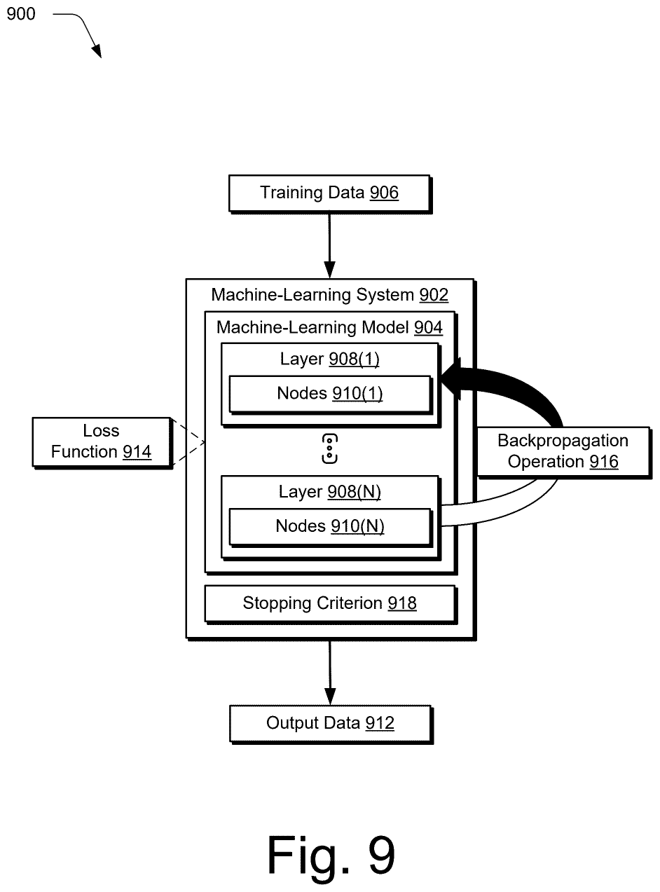

FIG. 9 depicts a system in an example implementation showing training of a machine-learning model of FIG. 1 in greater detail.

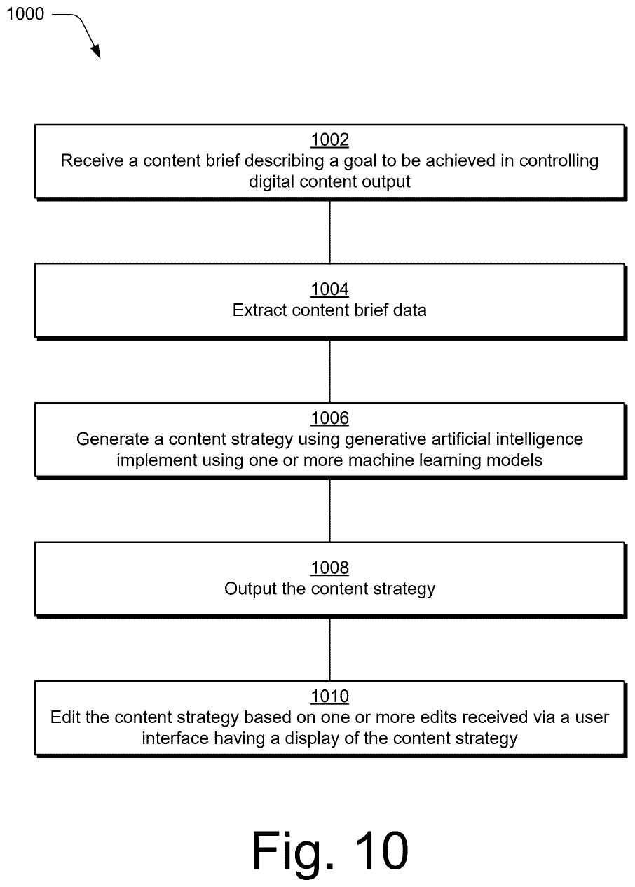

FIG. 10 is a flow diagram depicting an algorithm as a step-by-step procedure in an example implementation of operations performable for accomplishing a result of generative artificial intelligence content strategy generation using one or more machine-learning models.

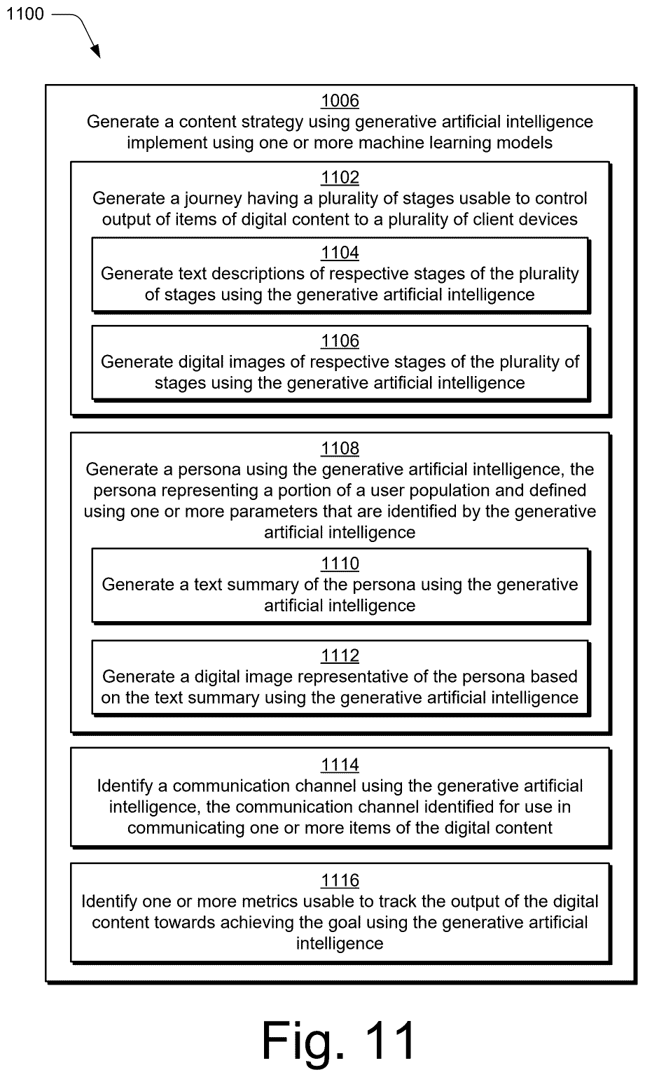

FIG. 11 is a flow diagram depicting an algorithm as a step-by-step procedure in an example implementation of operations performable for accomplishing a result of content strategy generation using one or more machine-learning models to generate a journey, a text summary, persona, and metrics using generative artificial intelligence.

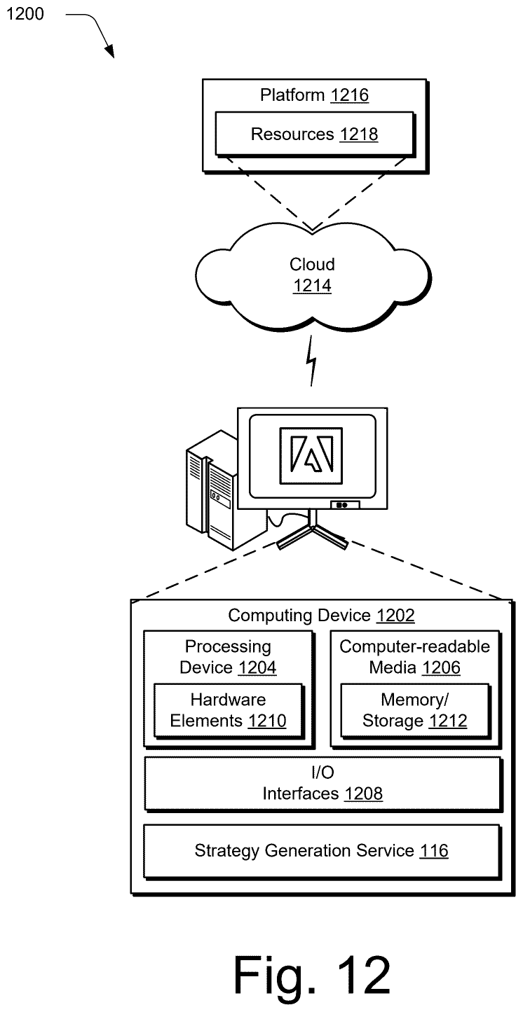

FIG. 12 illustrates an example system including various components of an example device that can be implemented as any type of computing device as described and/or utilize with reference to the previously figures to implement embodiments of the techniques described herein.

### DETAILED DESCRIPTION

### Overview

Conventional techniques involved in development of content strategies involve a manual and often laborious process in order to develop a plan in how to get a message across, what kind of stories are to be told to do so, how to guide potential consumer interaction, and so on. Additionally, conventional techniques used to describe the developed content strategies are difficult to understand without specialized knowledge. As a result, conventional techniques consume significant amounts of computational resources, a result of which is further difficult to judge or even determine in how to judge progress towards a goal of the strategies.

Accordingly, generative artificial intelligence content strategy techniques are described. In one or more examples, a content brief is received that describes a goal to be accomplished in controlling digital content output. The goal, for instance, may specify a generalized description such as “increase traffic into my coffee shop.” Complex goals are also supported, such as “a Mother's Day promotional offer in which any customer that spends over ten dollars is offered in a drawing for a chance to win free coffee for the month.”

A strategy generation service is then utilized to generate a content strategy based on the content brief that is usable to control output of digital content towards achieving the goal. The content strategy, for instance, is usable to control which items of digital content are provided to which entities (e.g., segments of a user population) to achieve the goal. To do so, the content strategy defines different aspects in how this control is to be performed. Examples of which include definition of a journey, text summary and digital image depicting the content strategy, a persona representing a portion of a user population that is to receive respective items of digital content, metrics usable to track output of the digital content towards achieving the goal, and so forth.

In order to generate the content strategy, the strategy generation service employs generative artificial intelligence as implemented using one or more machine-learning models. Examples of machine-learning models usable to do so include a text generative model (e.g., a large language model (LLM)), an image generative model (e.g., a diffusion-based model), a caption generation model, and so on.

An LLM is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language in order to generate an output. The use of the term “large” refers to both the size of the training data and also to the complexity and scale of the neural networks, which may include utilization of billions or even trillions of parameters.

A diffusion-based model, on the other hand, is trained to learn to remove noise added to training digital images as part of an iterative process. The process begins, for instance, by adding noise to a set of training digital images and the diffusion-based model is then trained to denoise the training digital images. Once trained, the diffusion-based model is configured to generate digital images based on a text input. Other examples of machine-learning models are also contemplated, including a machine-learning model configured to generate text based on a digital image such as a caption-generation model.

The strategy generation service is configured to generate the content strategy using generative artificial intelligence as implemented using one or more of the machine-learning models based on the content brief. Further, the strategy generation service is configured to express the content strategy in a way that is consumable without specialized knowledge, e.g., through use of text and digital images.

The strategy generation service, for instance, is configurable to generate a journey that is usable to control output of digital content through definition of a plurality of stages. The journey is illustrative of actions to be performed and responses to those actions as part of digital content control. The journey, for instance, is definable from a start point of awareness and may proceed through various stages (e.g., consideration, purchase, experience, advocacy, etc.) in order to achieve a goal defined by the content brief.

Each of the stages are generated in this example using generative artificial intelligence to include a textual description of what is to be performed at a respective stage, e.g., using a LLM. A digital image is also generated in this example for each stage representative of the textual description, e.g., using a diffusion based model based on the respective text description. In this way, automated generation of the journey by the strategy generation service provides a “playbook” of how and when digital content is to be output and includes textual descriptions and digital images depicting how this strategy is to be implemented.

The strategy generation service is also configurable to generate a persona using generative artificial intelligence based on the content brief. The persona is representative of a segment of a user population that is to receive the digital content, e.g., as specified as part of the journey. The persona, for instance, acts as a proxy for a target audience often having similar patterns of behavior.

The persona is definable using a variety of parameters that are generated using generative artificial intelligence, e.g., by an LLM. Like the journey example above, the strategy generation service is also configurable to generate a text summary of the persona using the LLM and a digital image representative of the persona based on the text summary using a diffusion-based model. The persona, as generated automatically and without user intervention by the strategy generation service, is therefore usable to provide a readily consumable view of a target audience without use of specialized knowledge.

The strategy generation service is further configurable to generate a text summary and a digital image representative of the overall content strategy. The strategy generation service, for instance, further employs the LLM to generate the text summary, e.g., based on the content brief, the journey and/or the persona. The text summary is also usable to generate a digital image representative of the overall strategy, e.g., as an input to a diffusion-based model. The text summary and digital image, as generated automatically and without user intervention by the strategy generation service, is therefore usable to provide a readily consumable view of how the overall goal defined by the content brief is to be achieved through output of digital content.

The strategy generation service is further configurable to generate metrics usable to track output of the digital content towards achieving the goal. For example, the strategy generation service is configurable to employ generative artificial intelligence to determine which metrics are usable to track progress towards the goal. Example of the metrics include impressions, reach, engagement, click-through rate (CTR), conversion rate, cost-per-click, cost-per-acquisition, and so on. In this way, generative artificial intelligence is employed to automatically identify ways in which progress may be tracked in the output of the digital content towards achieving the goal.

The strategy generation service, therefore, through generating the content strategy from the content brief is usable to define a strategy to control output of digital content through a variety of stages, define those stages, a persona representative of a population segment that is to receive the digital content, and identify metrics usable to track progress towards achieved a goal of the strategy. As a result, the strategy generation service addresses conventional technical challenges in development of content strategies involving a manual inputs and specialized knowledge, the results of which are difficult to judge progress towards a goal of the strategies. Further discussion of these and other examples is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

A “diffusion model” is a type of generative machine-learning model that is used for digital content creation, e.g., digital images. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Generative Artificial Intelligence Environment

FIG. 1 is an illustration of an environment 100 in an example implementation that is operable to employ generative artificial intelligence (AI) content strategy generation techniques described herein. The illustrated environment 100 includes a service provider system 102 and a computing device 104 that are communicatively coupled, one to another, via a network 106. Computing devices are configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 12.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement a strategy generation service 116. The strategy generation service 116 is configured to employ generative artificial intelligence implemented using one or more machine-learning models 118. The strategy generation service 116 employs the one or more machine-learning models 118 to take, as an input, a content brief 120 and from this generate a content strategy 122 using generative artificial intelligence. The content strategy 122 is usable to control output of digital content 124 (which is illustrated as stored in a storage device 126) to a user population 128 to achieve a goal identified from the content brief 120.

The strategy generation service 116 is configured to address the technical challenges of conventional techniques involving a tedious and error-prone process of achieving a desired goal, such as how to get a message across, what kind of stories are to be told, how to guide the user population 128, and so forth. Formulating content strategy 122 involves a substantial amount of complexity, creative thought, and an ability to understand behaviors of the user population 128 that are difficult to quantify or translate into an algorithmic language for automation. For instance, crafting a visualization of a customer's journey, which is pivotal in understanding the touchpoints and decision-making process of a potential audience, involves a blend of analytical and artistic proficiencies. These proficiencies include, but are not limited to, the creation of engaging narratives, aesthetic arrangement of information, and adaptive representation of complex data, each of which are challenging to encapsulate within the rigid framework of a computer program. Additionally, the dynamic nature of market trends, consumer preferences, and competitive activities compounds the difficulty of automating such a process. To operate correctly, each content strategy is to be tailored and flexible to adapt to these ever-changing conditions, a task that conventional techniques are incapable of accomplishing with finesse and judgment.

Accordingly, the strategy generation service 116 supports automation through use of the one or more machine-learning models 118 in generation of the content strategy 122. The content strategy 122 is usable to define who is to receive a message, what kinds of stories are to be told, and how to guide the user population 128 towards performing a desired action, e.g., a goal. Conventional techniques to do so involve specialized knowledge involving technical and strategic expertise, and thus pose significant technical difficulties that are not available to common users.

The strategy generation service 116, for instance, is configurable to receive the content brief 120 in a portable document format (PDF) and from this generate a comprehensive content strategy 122, automatically and without user intervention. By streamlining the content strategy 122 generation process, the strategy generation service 116 increases accessibility and reduces computational resource consumption with increased time efficiency, especially for individuals with limited experience. Further discussion of these and other technical advantages are included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Generative Artificial Intelligence (AI) Content Strategy

The following discussion describes content strategy techniques utilizing generative artificial intelligence (AI) that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 10 is a flow diagram depicting an algorithm 1000 as a step-by-step procedure in an example implementation of operations performable for accomplishing a result of generative artificial intelligence content strategy generation using one or more machine-learning models. FIG. 11 is a flow diagram depicting an algorithm 1100 as a step-by-step procedure in an example implementation of operations performable for accomplishing a result of content strategy generation using one or more machine-learning models to generate a journey, a text summary, persona, and metrics using generative artificial intelligence. In the following discussion, reference is made in parallel to the algorithms 1000, 1100 of FIGS. 10 and 11.

FIG. 2 depicts a system 200 in an example implementation showing operation of the strategy generation service 116 of FIG. 1 in greater detail as generating a content strategy 122 from a content brief 120. The strategy generation service 116 begins in this example by receiving a content brief 120 describing a goal to be achieve in controlling digital content output (block 1002). The goal, for instance, may specify a generalized description such as “increase traffic into my coffee shop.” Complex goals are also supported, such as “a Mother's Day promotional offer in which any customer that spends over ten dollars is offered in a drawing for a chance to win free coffee for the month.”

FIG. 3 depicts an example 300 implementation of a content brief 120. The content brief 120 includes a title (e.g., “Mother's Day Promotion”) and also specifies dates associated with a goal, e.g., “Friday 26^{th} April 2024-Friday 10^{th} May 2024.” A promotional offer is specified as “Spend over $10 at any location nationwide and enter your mother in the draw to win a coffee a day for a month.” A promotional period is also specified includes the dates above, as well as indicating specific times when the promotion opens and closes, when a drawing is to be made, and duration.

Promotional objectives and rationale are specified. Examples include “Increase ATV through promotional period compared to last 2023,” “Increase Customer Count through promotional period compared to last 2023,” “Increase sales through driving customers count and acquisition of new customers by offering them a great prize incentive,” “Reward existing customers for their loyalty,” and “Data collection.”

A target audience is also described. In the illustrated example, the target audience includes “Single coffer drinkers; or ultimately those who spend under $10 on average in store—You are to up-sell them with any add on item to get in to the prize draw.” The target audience also includes “People wanting to treat their mums for Mother's day.”

Promotional details include a promotional message of “Spend $10 or more in store in one transaction. One winner per store nationwide. It's our way of celebrating Mothers this May!” Promotional details also include “How do customers know about our Mother's Day competition?” Examples of which include “Online advertising—via promoted/sponsored Facebook Posts,” “Email will be sent to all loyalty card members,” and “Point of sale posters.” Thus, the content brief 120 supports an informal technique to specify goals of digital content output control.

Returning again to FIG. 2, a data extraction module 202 is then employed to extract content brief data 204 from the content brief 120 (block 1004). Examples of functionality executable to do so include a text recognition module 206 and an image processing module 208. The text recognition module 206 is configured to extract features from the content brief 120, e.g., through use of optical character recognition. The text recognition module 206, for instance, is configurable to extract closed loops, lines, line directions, and intersections to recognize characters or other glyphs in the content brief 120 as part of extracting the content brief data 204, e.g., as text.

The image processing module 208, on the other hand, is configured to generate text based on one or more digital images included in the content brief 120. The image processing module 208, for instance, is configured as an image captioning module 210 that utilizes machine learning to generate text that corresponds to a digital image using image understanding and language modeling. The image captioning module 210, in one or more examples, includes a convolutional neural network to extract features from the digital image. A long short-term memory (LSTM) is then employed, which is a type of recurrent neural network (RNN), to learn text features and employ sequence prediction to combine extracted image features and learned text features to generate the text as describing the digital image. The text is then also included as part of the content brief data 204 in this example. A variety of other examples are also contemplated.

The content brief data 204 is then passed as an input from the data extraction module 202 to a strategy generation module 212. The strategy generation module 212 is configured to generate a content strategy 122 using generative artificial intelligence implemented using one or more machine learning models (block 1006). In the illustrated example, the strategy generation module 212 selects a strategy template 214 from a plurality of strategy templates 214 based on the content brief data 204. The strategy generation module 212, for instance, selects the strategy template 214 based on which fields are included in the content brief data 204, which aspects of the content strategy 122 are to be generated based on the content brief data 204, and so forth.

Functionality usable to generate respective aspects of the content strategy 122 are illustrated as a journey generation module 216, a persona generation module 218, a channel identification module 220, and a metrics generation module 222. FIG. 4 depicts an example implementation 400 in which the strategy generation module 212 is employed to populate portions the strategy template 214 using respective modules to implement generative artificial intelligence to generate text and/or digital images based on the content brief 120. FIG. 5 depicts an example implementation 500 showing a content strategy 122 as having respective portions the strategy template 214 populated using generative artificial intelligence as implemented using respective modules based on the content brief 120.

The journey generation module 216 is configured to generate a journey 502 having a plurality of stages usable to control output of items of digital content to a plurality of client devices (block 1102). The journey generation module 216, for instance, is configurable to generate text descriptions of respective stages of the plurality of stages using the generative artificial intelligence (block 1104). The journey generation module 216 is also configurable to generate digital images of respective stages of the plurality of stages using the generative artificial intelligence (block 1106).

The journey generation module 216, for instance, is configurable to use generative artificial intelligence as implemented using a large language model (LLM) of the one or more machine-learning models 118 to generate stages to be used to control output of digital content. The LLM is also configurable to generate text describing actions associated with the respective stages. The LLM, for instance, is configurable to determine what actions (including inactions) may be encountered as part of achieving the goal specified by the content brief 120.

The journey 502 is illustrative of actions to be performed and responses to those actions as part of digital content control. The journey 502, for instance, is definable from a start point 504 of introducing a persona representative of segment of a user population that is a target of the journey 502. The journey 502 then includes subsequent stages 506, 508, 510, 512, 514 of actions either undertaken by the persona and/or the service provider system 102 in controlling output of the digital content 124. Each of the stages are generated in this example using generative artificial intelligence to include a textual description of what is to be performed at a respective stage, e.g., using an LLM.

A digital image is also generated in this example for each stage representative of the textual description, e.g., using a diffusion based model of the one or more machine-learning models 118 based on the respective text description. In this way, automated generation of the journey 502 by the journey generation module 216 provides a “playbook” of how and when digital content 124 is to be output and includes textual descriptions and digital images depicting how this strategy is to be implemented. Through use of generative artificial intelligence, the journey generation module 216 is configured to expand beyond information included in the content brief 120 to create a strategy in how to achieve a goal discerned form the content brief 120, automatically and without user intervention.

The persona generation module 218 is configured to generate a persona using the generative artificial intelligence. The persona represents a portion of a user population and is defined using one or more parameters that are identified by the generative artificial intelligence (block 1108). The persona generation module 218, for instance, is configurable to generate a text summary of the persona using the generative artificial intelligence (block 1110). The persona generation module 218 is also configurable to generate a digital image representative of the persona based on the text summary using the generative artificial intelligence (block 1112).

FIG. 6 depicts an example implementation of output of a persona 600 in a user interface as generated by a persona generation module 218. The persona 600 is depicted as including an identifier 602 of the overall persona, such as “Sara the Mother's Day Shopper” and a natural language summary 604 of “Sara is a loyal customer who is a frequent coffee drinker and is looking for a special treat for her mother this Mother's Day. She is intrigued by the promotional offer and is considering participating in the competition.” The identifier 602 and the natural language summary 604 are generated in this example using a LLM.

The persona 600 also includes a digital image 606 representative of the overall persona. The one or more machine-learning models 118, for instance, include a diffusion-based model to generate the 606 based on the natural language summary 604, the identifier 602, parameters 608 generated as a basis to define the persona 600, and so forth. The persona generation module 218, for instance, through use of a LLM generates parameters that are usable to specify a segment of a user population that is to be used as a basis to achieve the goal. In the illustrated example, the parameters 608 include demographics such as age, schooling, gender, location, and income. Based on the parameters, the persona generation module 218 determines a number 610 of members of a population that meets those parameters.

The persona 600 also includes psychographics 612 generated using the one or more machine-learning models 118 (e.g., a LLM) that describe psychological variables usable to classify population groups (e.g., “value seeker” and “gift giver”) which include corresponding textual descriptions in FIG. 6. The persona 600 further supports editing such that once a desired persona is created, an option 614 is selectable via the user interface to automate implementation of the persona into digital services to execute the content strategy 122, e.g., through output of digital content 124.

FIG. 7 depicts an example implementation of output of a persona 700 in a user interface as generated by a persona generation module 218 based on one or more edits to the persona 600 of FIG. 6. In this example, an edit is received via a user interface to one or more of the parameters 608 of FIG. 6. Other edits are also contemplated, e.g., to the identifier 602, natural language summary 604, digital image 606, psychographics 612, and so forth.

In response, the persona generation module 218 regenerates the persona 600 to form persona 700. The persona 700 includes a same identifier 702 as the identifier 602 of FIG. 6, but a natural language summary 704 is updated to reflect a change to the parameters 708 using an LLM. Likewise, a digital image 706 is also regenerated using a diffusion-based model of the one or more machine-learning models 118, e.g., based on the change to the parameters 708, the natural language summary 704, or other inputs. A number 710 of a population meeting the parameters 708 is further updated and therefore provides insight into an effect of the edit. The psychographics 712 are also updated to reflect “value driven” and “family oriented.” Thus, the persona generation module 218 is configurable to update the persona 700 in real time as user inputs are received through execution of the one or more machine-learning models 118. Once completed, the option 714 is selectable to initiate execution of the content strategy by the digital services 112, automatically and without further user intervention

The channel identification module 220 is configured to identify a communication channel using the generative artificial intelligence. The communication channel is identified for use in communicating one or more items of the digital content (block 1114). The content strategy 122 as shown in FIG. 5, for instance, identifies channels 516 usable to communicate the digital content as generated using a LLM using generative artificial intelligence based on the content brief 120. Illustrated examples include “Email Marketing to engage with existing loyalty card members and provide them with exclusive information,” “In-Store Promotion to directly engage with customers and encourage them to participate in the promotion,” and “Online Advertising to reach a wide audience and leverage the power of social media.” In this way, the channel identification module 220 employs generative artificial intelligence to identify “how” the digital content 124 is to be communicated to the user population 128.

The metrics generation module 222 is configured to employ generative artificial intelligence to identify one or more metrics 518 usable to track the output of the digital content towards achieving the goal (block 1116). For example, the metrics generation module 222 is configurable to employ generative artificial intelligence to determine which metrics are usable to track progress towards the goal. Examples of the metrics include impressions, reach, engagement, click-through rate (CTR), conversion rate, cost-per-click, cost-per-acquisition, and so on. In this way, generative artificial intelligence is employed by the metrics generation module 222 to automatically identify ways in which progress may be tracked in the output of the digital content towards achieving the goal. In this illustrated example, for instance, metrics 518 include “Increase average transaction value (ATV) through promotional period compared to 2023,” “Increase customer count through promotional period compared to 2023,” and “increase sales driving customer count and acquisition of new customers by offering them a great prize incentive.” Other examples are also contemplated.

The strategy generation module 212 is further configurable to generate a text summary and a digital image representative of the overall content strategy. The strategy generation module 212, for instance, further employs the LLM and/or diffusion-based model of the one or more machine-learning models 118 to generate a title 520, a text summary 522, and/or a digital image 524 representative of the content strategy 122 as a whole. For example, the text summary 522 as generated by the LLM is usable by a diffusion-based model to generate a digital image representative of the overall strategy. The text summary and digital image, as generated automatically and without user intervention by the strategy generation service, is therefore usable to provide a readily consumable view of how the overall goal defined by the content brief is to be achieved through output of digital content.

The content strategy 122 is then output (block 1008) to a strategy export module 224. The strategy export module 224 is configurable to support a variety of functionality. Examples of these functionalities include display in a user interface as output by a user interface module 226, export for automated implementation of the content strategy 122 by the digital services 112 using a digital service export module 228, metric tracking as implemented by a strategy tracking module 230, and so on. The content strategy 122, for instance, supports edits received via output in a user interface by the user interface module 226 (block 1010).

The content strategy 122, for instance, is displayed in a user interface module 226 by the strategy export module 224. Edits are supported, and once a desired strategy is obtained, the digital service export module 228 exports the content strategy 122 to respective digital services 112. The digital services 112 are associated with output of the digital content 124 using respective channels, e.g., email, instant messaging, social media services, and so forth. The strategy tracking module 230 is then utilized to track metrics specified by the content strategy 122 that are usable to judge progress of the content strategy 122 towards achieving the goal. FIG. 8 depicts an example of a user interface 800 depicting a journey and respective metrics usable to track performance of a content strategy generated using generative artificial intelligence.

The strategy generation service 116, therefore, through generating the content strategy from the content brief is usable to define operations to control output of digital content through a variety of stages, define those stages, a persona representative of a population segment that is to receive the digital content, and identify metrics usable to track progress towards achieved a goal of the strategy. As a result, the strategy generation service addresses conventional technical challenges in development of content strategies involving a manual inputs and specialized knowledge, the results of which are difficult to judge progress towards a goal of the strategies.

FIG. 9 depicts a system 900 in an example implementation showing training of a machine-learning model of FIG. 1 in greater detail. The machine-learning model 902 is illustrated as implemented as part of a machine-learning system 904. The machine-learning system 904 is representative of functionality to generate training data 906, use the generated training data 906 to train the machine-learning model 902, and/or use the machine-learning model 902 as trained to implement the functionality described herein.

A machine-learning model 904 refers to a computer representation that is tunable (e.g., through training and retraining) based on inputs without being actively programmed by a user to approximate unknown functions, automatically and without user intervention. In particular, the term machine-learning model includes a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In the illustrated example, the machine-learning model 904 is configured using a plurality of layers 908(1), . . . , 908(N) having, respectively, a plurality of nodes 910(!), . . . , 910(N). The plurality of layers 908(1)-911(N) are configurable to include an input layer, an output layer, and one or more hidden layers. Calculations are performed by the nodes 910(1)-910(N) within the layers via hidden states through a system of weighted connections that are “learned” during training of the machine-learning model 904 to implement a variety of tasks.

In order to train the machine-learning model 904, training data 906 is received that provides examples of “what is to be learned” by the machine-learning model 904, i.e., as a basis to learn patterns from the data. The machine-learning system 902, for instance, collects and preprocesses the training data 906 that includes input features and corresponding target labels, i.e., of what is exhibited by the input features. The machine-learning system 902 then initializes parameters of the machine-learning model 904, which are used by the machine-learning model 904 as internal variables to represent and process information during training and represent interferences gained through training. In an implementation, the training data 906 is separated into batches to improve processing and optimization efficiency of the parameters of the machine-learning model 904 during training.

The training data 906 is then received as an input by the machine-learning model 904 and used as a basis for generating predictions based on a current state of parameters of layers 908(!)-908(N) and corresponding nodes 910(1)-910(N) of the model, a result of which is output as output data 912. Output data 912 describes an outcome of the task, e.g., as a probability of being a member of a particular class in a classification scenario.

Training of the machine-learning model 904 includes calculating a loss function 914 to quantify a loss associated with operations performed by nodes of the machine-learning model 904. The calculating of the loss function 914, for instance, includes comparing a difference between predictions specified in the output data 912 with target labels specified by the training data 906. The loss function 914 is configurable in a variety of ways, examples of which include regret, Quadratic loss function as part of a least squares technique, and so forth.

Calculation of the loss function 914 also includes use a backpropagation operation 916 as part of minimizing the loss function 914 and thereby training parameters of the machine-learning model 904. Minimizing the loss function 914, for instance, includes adjusting weights of the nodes 910(1)-910(N) in order to minimize the loss and thereby optimize performance of the machine-learning model 904 in performance of a particular task. The adjustment is determined by computing a gradient of the loss function 914, which indicates a direction to be used in order to adjust the parameters to minimize the loss. The parameters of the machine-learning model 904 are then updated based on the computed gradient.

This process continues over a plurality of iteration in an example until a stopping criterion 918 is met. The stopping criterion 918 is employed by the machine-learning system 902 in this example to reduce overfitting of the machine-learning model 904, reduce computational resource consumption, and promote an ability of the machine-learning model 904 to address previously unseen data, i.e., that is not included specifically as an example in the training data 906. Examples of a stopping criterion 918 include but are not limited to a predefined number of epochs, validation loss stabilization, achievement of a performance improvement threshold, or based on performance metrics such as precision and recall.

Configuration of the training data 906 is usable to support a variety of usage scenarios. In one example, the training data 906 is configured in support of machine-learning functionality usable to implement the journey generation module 216, persona generation module 218, channel identification module 220, metrics generation module 222, and so on.

### Example System and Device

FIG. 12 illustrates an example system generally at 1200 that includes an example computing device 1202 that is representative of one or more computing systems and/or devices that implement the various techniques described herein. This is illustrated through inclusion of the strategy generation service 116. The computing device 1202 is configurable, for example, as a server of a service provider, a device associated with a client (e.g., a client device), an on-chip system, and/or any other suitable computing device or computing system.

The example computing device 1202 as illustrated includes a processing device 1204, one or more computer-readable media 1206, and one or more I/O interface 1208 that are communicatively coupled, one to another. Although not shown, the computing device 1202 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1204 is representative of functionality to perform one or more operations using hardware. Accordingly, the processing device 1204 is illustrated as including hardware element 1210 that is configurable as processors, functional blocks, and so forth. This includes implementation in hardware as an application specific integrated circuit or other logic device formed using one or more semiconductors. The hardware elements 1210 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1206 is illustrated as including memory/storage 1212 that stores instructions that are executable to cause the processing device 1204 to perform operations. The memory/storage 1212 represents memory/storage capacity associated with one or more computer-readable media. The memory/storage 1212 includes volatile media (such as random access memory (RAM)) and/or nonvolatile media (such as read only memory (ROM), Flash memory, optical disks, magnetic disks, and so forth). The memory/storage 1212 includes fixed media (e.g., RAM, ROM, a fixed hard drive, and so on) as well as removable media (e.g., Flash memory, a removable hard drive, an optical disc, and so forth). The computer-readable media 1206 is configurable in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1202. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1202, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1210. The computing device 1202 is configured to implement particular instructions and/or functions corresponding to the software and/or hardware modules. Accordingly, implementation of a module that is executable by the computing device 1202 as software is achieved at least partially in hardware, e.g., through use of computer-readable storage media and/or hardware elements 1210 of the processing device 1204. The instructions and/or functions are executable/operable by one or more articles of manufacture (for example, one or more computing devices 1202 and/or processing devices 1204) to implement techniques, modules, and examples described herein.

The techniques described herein are supported by various configurations of the computing device 1202 and are not limited to the specific examples of the techniques described herein. This functionality is also implementable all or in part through use of a distributed system, such as over a “cloud” 1214 via a platform 1216 as described below.

The cloud 1214 includes and/or is representative of a platform 1216 for resources 1218. The platform 1216 abstracts underlying functionality of hardware (e.g., servers) and software resources of the cloud 1214. The resources 1218 include applications and/or data that can be utilized while computer processing is executed on servers that are remote from the computing device 1202. Resources 1218 can also include services provided over the Internet and/or through a subscriber network, such as a cellular or Wi-Fi network.

The platform 1216 abstracts resources and functions to connect the computing device 1202 with other computing devices. The platform 1216 also serves to abstract scaling of resources to provide a corresponding level of scale to encountered demand for the resources 1218 that are implemented via the platform 1216. Accordingly, in an interconnected device embodiment, implementation of functionality described herein is distributable throughout the system 1200. For example, the functionality is implementable in part on the computing device 1202 as well as via the platform 1216 that abstracts the functionality of the cloud 1214.

In implementations, the platform 1216 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
receiving, by a processing device, a content brief describing a goal to be achieved in controlling digital content output;
extracting, by the processing device, content brief data from the content brief;
generating, by the processing device, a content strategy based on the content brief data using generative artificial intelligence implemented using one or more machine-learning models, the content strategy including a journey having a plurality of stages usable to control output of items of digital content to a plurality of client devices, the generating including:
generating text descriptions of respective stages of the plurality of stages using the generative artificial intelligence; and
generating digital images of respective stages of the plurality of stages using the generative artificial intelligence; and
outputting, by the processing device, the content strategy for display in a user interface.

2. The method as described in claim 1, wherein the content brief data is text and the generating of the content strategy is based on the text.

3. The method as described in claim 2, wherein the extracting is performed using a machine-learning model to extract, using image understanding and language modeling, at least a portion of the text based on a digital image included in the content brief.

4. The method as described in claim 1, wherein the generating of the content strategy includes:
generating text descriptions of respective stages of the plurality of stages using large language model (LLM); and
generating digital images of respective stages of the plurality of stages using a diffusion model.

5. The method as described in claim 41, wherein the generating of the digital images is performed by the generative artificial intelligence based on respective said text descriptions for a corresponding said stage.

6. The method as described in claim 1, wherein the generating of the content strategy includes:
generating a text summary of the content strategy using the generative artificial intelligence; and
generating a digital image of the content strategy based on the text summary using the generative artificial intelligence.

7. The method as described in claim 1, wherein the generating of the content strategy includes generating a persona using the generative artificial intelligence, the persona representing a portion of a user population and defined using one or more parameters that are identified by the generative artificial intelligence.

8. The method as described in claim 7, wherein the generating of the persona includes:
generating a text summary of the persona using the generative artificial intelligence; and
generating a digital image representative of the persona based on the text summary using the generative artificial intelligence.

9. The method as described in claim 8, further comprising receiving an input specifying an edit to at least one of the parameters and regenerating the persona based on the edit using the generative artificial intelligence.

10. The method as described in claim 1, wherein the generating of the content strategy includes identifying a communication channel using the generative artificial intelligence, the communication channel identified for use in communicating one or more items of the digital content.

11. The method as described in claim 1, wherein the generating of the content strategy includes identifying one or more metrics usable to track the output of the digital content towards achieving the goal using the generative artificial intelligence.

12. The method as described in claim 1, wherein the generating of the content strategy includes:
selecting a strategy template from a plurality of strategy templates based on the generative artificial intelligence; and
populating the selected strategy template using the generative artificial intelligence based on the content brief data.

13. A method comprising:
generating a content strategy based on a goal to be achieved in controlling digital content output, the generating performed using generative artificial intelligence implemented using one or more machine-learning models, the content strategy including:
a journey having a plurality of stages usable to control output of items of digital content to a plurality of client devices, the journey depicted using text and digital images generated based on the text using the generative artificial intelligence;
a persona representing a portion of a user population that is to receive the output of the items of digital content and defined using parameters that are identified using the generative artificial intelligence, the persona depicted using a digital image generated based at least in part on the parameters using the generative artificial intelligence;
a communication channel identified for use in communicating one or more items of the digital content using the generative artificial intelligence; and
one or more metrics usable to track the output of the digital content towards achieving the goal using the generative artificial intelligence; and
editing the content strategy based on one or more edits received via a user interface having a display of the content strategy.

14. The method as described in claim 13, wherein the content strategy includes a text summary of the content strategy generated using the generative artificial intelligence.

15. The method as described in claim 14, wherein the content strategy includes a digital image representative of the content strategy generated based on the text summary using the generative artificial intelligence.

16. The method as described in claim 13, wherein the generating is based on a content brief describing the goal to be achieved in controlling digital content output.

17. One or more computer-readable storage media storing instructions that, responsive to execution by a processing device, causes the processing device to perform operations including:
receiving a content brief describing a goal to be achieved in controlling digital content output;
extracting content brief data as text from the content brief;
generating a content strategy based on the text using generative artificial intelligence implemented using one or more machine-learning models, the content strategy including one or more metrics usable to track output of digital content towards achieving the goal, the generating including:
generating text descriptions of respective stages of a plurality of stages using a large language model (LLM); and
generating digital images of respective stages of the plurality of stages using a diffusion model; and
outputting the content strategy for display in a user interface.

18. The one or more computer-readable storage media as described in claim 17, wherein the content strategy includes one or more metrics usable to track output of digital content towards achieving the goal.

19. The one or more computer-readable storage media as described in claim 17, wherein the generating of the content strategy includes:
generating a text summary of the content strategy using the generative artificial intelligence; and
generating a digital image of the content strategy based on the text summary using the generative artificial intelligence.

20. The one or more computer-readable storage media as described in claim 17, wherein the generating of the content strategy includes generating a persona using the generative artificial intelligence, the persona representing a portion of a user population and defined using one or more parameters that are identified by the generative artificial intelligence.
